(19) United States
(12) Patent Application Publication
(10) Pub. No.: US 2011/0003687 A1
(43) Pub. Date: Jan. 6, 2011

(54) Development Of A Thermal Paper Produced On A Very Smooth Paper

(76) Inventors: Ricardo Millares Neyra, Delegacion Azcapotzalco (MX); Ricardo Millares Sotres, Delegacion Azcapotzalco (MX); Dalila Rivera Carmona, Delegacion Azcapotzalco (MX)

Correspondence Address: LADAS & PARRY LLP, 26 WEST 61ST STREET, NEW YORK, NY, 10023, US

(21) Appl. No.: 12/742,174

(22) PCT Filed: Nov. 11, 2008
(86) PCT No.: PCT/MX2008/000153

§ 371 Date: Sep. 20, 2010

(30) Foreign Application Priority Data
Nov. 20, 2007 (MX) MX/A/2007/014121

(51) Int. Cl. B41M 5/337; B05D 5/06; B41M 5/30

(52) U.S. Cl. 503/209; 427/150; 503/226

(57) ABSTRACT

A thermal paper is described for the formation of images in thermal printing equipment and their manufacturing process, using high smoothness paper as a base or substrate. The thermal paper object of this invention is more economical and has a fully-acceptable performance. The high smoothness non-coated base paper has a greater high smoothness superficial finish than uncoated paper, and this development had not previously been used industrially for this purpose, since on trying to use the state of art of the process coupled with uncoated paper characteristics, the result was a low quality product. Hence, until now base papers had to be used with a previous coating the preparation of which increased production costs due to finished product characteristics, such as heavier weight (weight by square meter) and also a higher caliber.

### SCOPE OF THE INVENTION

A method to obtain a paper with thermo sensitive surface characteristics is described, consisting of covering a sheet of paper having a high smoothness with a thermal material layer promoting the development of images in a wide range of thermal printers.

### OBJECT OF THE INVENTION

The object of the present invention is to obtain a thermal paper with which clear and defined prints can be obtained from the thermal printers, using papers with a high smoothness as a base. A lower production cost is obtained as a need for previous covering of the basic paper is eliminated, and the thermal paper's performance requirements for today's high speed thermal printers for high definition images for various uses is met, as prints that including bar codes must be legible for optical readers.

The present invention permits in the manufacturing process, a fresh thickness calibration of the thermo sensitive layer through the use of Coating Rods, which is a more economic process than others used in the state of the art. The formula described at the present invention permits the thermo sensitive layer to uniformly cover the basic paper and presents a uniform and smooth surface, different from the roughness in the form of grooves typical of the calibrated coatings with Coating Rods, as described in various patents related, allowing the thermo sensitive layer to process the adherence and stability required so as to not be detached during printing, writing, or handling of the print.

### ANTECEDENTS

According to the state of the art, the material used in the thermal printers is a sheet of paper with a preliminary coating layer which diminishes roughness and increases the smoothness to which the layer of thermo sensitive color is applied. The thermo sensitive layer consists of a color former, a color developer and a sensitizer, besides the white pigments and lubricant additives.

In thermal paper production, pre-covered papers with pigments and adhesives as substrate that do not react with the thermo sensitive layer are normally used. Besides reducing the natural roughness of the paper, these pre-covering layers help to fix the thermo sensitive layer. This operation is mentioned in the following patents: U.S. Pat. No. 6,165,937 as of 26-12-2000, U.S. Pat. No. 6,613,716 B2 as of 2-09-2003, WO2005084958 as of 15-09-2005. The use of pre-covered papers implies an additional step in the process and increases the cost of the production.

In the same way, if it is desired to utilize a paper without a pre-coating base, a sufficiently thick thermo sensitive layer must be applied to compensate for the roughness of the paper, and product cost would be considerably increased.

The base paper used according to the actual State of the art is one that bearing a previous layer to increase smoothness, over which a thermo sensitive layer is applied which, when receiving heat, generates a black or almost black color image. This active or thermo sensitive layer consists of a color former, a color developer and a sensitizer. It also has additives such as white pigments and lubricants. This type of product and component are described in the following patents: U.S. Pat. No. 4,425,161 U.S. Pat. No. 5,741,592 as of 21-04-1998, U.S. Pat. No. 6,165,937 as of 26-12-2000, U.S. Pat. No. 6,562,755 B1 as of 13-05-2003, U.S. Pat. No. 6,613,716 B2 as of 02-09-2003, WO2005032838 as of 14-04-2005, WO2005084958 as of 15-09-2005.

Until now, before the present invention papers with a high smoothness have not been used because, even though these possess the required surface smoothness uniformity, this same characteristic has hindered fixation of the thermo sensitive layer in the manufacturing process, as well as in its applications.

Considering the actual state of art, the application of the thermo sensitive layer by aqueous dispersal is effected mainly through “controlled grooving” by very precise systems, requiring high machinery and equipment investments.

As mentioned in previous paragraphs, the thermo sensitive layer consists of several components: color former, color developer and sensitizer as described below:

Color formers made up of Diamino fluoran, Diarylmethane and Azaphtalides compounds. Among these color formers are some able to develop a blue coloring, such as the CVL (Caprolactam of Crystal Violet), reddish tones and a black tone.

Color formers include among others: Diarylmethanes as 4,4-bis (dimethylamine benzhydroxyl benzyl) ether, N-halophenyl leuco auramine, N-2,4,5-trichlorophenyl leuco auramine; Fluoran as 2-dibenzilamine-6-diethylamino fluoran, 2-fluoran, 3-methylaniline-6-diethylamino fluoran, 2-aniline-3-methyl-6-diethylamino fluorano, 2-aniline-3-methyl-6-(ethyl isopentylamine) fluoran, 3,6-dimethoxy fluoran, 7,7′-bis-(3-diethylamino fluoran); Spiro-pyrans as 3-methyl-spiro-dinaphtopyran, 3-ethyl-spiro-dinaphtopyran, 3-benzyl-spiro-dinaphtopyran, 3,3′-diclhoro-spiro-dinaphtopyran, 3-methylnaphto-(3-methoxybenzoato)-spiro-pyran; Azaphtalides as 3-(2-ethoxy-4-diethyl-aminophenil)-3-(octyl-2-methylindole-3-1)-4-azaphtalide, 3-(2-ethoxy-4-diethyl-aminaphenil)-3-(1-ethyl-2-methylindole-3-1)-4-azaphtalide and Indolphtalides 3-(p-dimethyl aminopheni1)-3-(1,2-dimethylindo1-3-1) phthalide, 3-(p-dimethylaminopheni1)-3-(2-methylindole-3-1) phthalide. Color developers which are fenolic compounds such as: Benzyl-4-hydroxybenzoate, Bis-(3-allyl-4-hydroxyphenyl) sulfone, 2,4-dihydroxydiphenil sulfone, 4-hydroxyphenyl-4-isopropoxyphenyl sulfone, p-hydroxybenzyl phenol, 4,4-disulfonyl phenol, 3-benzyl salicylic acid, 3-isopropyl salicylic acid, 4,4′-tiodiphenol phenol-formaldehyde resin novrolac, Alphanaphtol, Bisphenol-A, Bisphenol sulfone, 3,5-dimethyl-4-hydroxy benzoic acid, 4-4′-isopropyl diphenol and 3-3 ‘-dimethyl-4-4’-tiodiphenol.

Sensitizers can be compounds of fatty acids, such as acetamide, stearic acid amides and acid compounds parahydroxy benzoic, dimethyl terephthalate and dibenzyl terephthalate.

Another fundamental compound for the layer structure with good optical properties are the white pigments or loads such as, precipitated Calcium Carbonate, calcined kaolin, silica, calcined clay and/or plastic spheres.

### DESCRIPTION OF THE INVENTION

The present invention refers to the use of a paper base having a high smoothness as substrate that is coated with a thermo sensitive layer to heat formed by a fine aqueous dispersal (emulsion) of color formers, color developers and sensitizers that are initially white or colorless but when thermal energy is applied they become mainly black or blue, producing the required images. In the formula for said emulsion object of the present invention it is understood the incorporation of a surfactant additive, defoamants, pigments or white loads and natural adhesives as modified starches and/r synthetic as low viscosity partially hydrolyzed polyvinyl alcohol and emulsion terpolymers, consisting on vinyl acetate, Veova (versatic acid vinyl ester), and from acrylic ester plasticizer free.

By the use of Paper with a High Smoothness as Base it is possible to eliminate the surface pre-coating, as the smoothness from the paper provides a suitable base over which the thermo sensitive layer containing color formers that give the paper a surface sensitive to heat able to reproduce the required images can be set.

In the present invention a formula is developed which permits the coating and calibration of the thickness mechanism of the thermo sensitive layer when freshly applied through the coating rods process. The rheological and superficial tension characteristics of this formula have the effect of eliminating the characteristic process trace while the emulsion is still fresh, and without leaving a trace on the dry surface. That way a uniformity and smoothness of the thermo sensitive layer is obtained which is more uniform than normally obtained with this type of rods. This calibration process is more economical than other alternative processes of coating such as the curtain or controlled high precision grooving process.

An additional characteristic of the present invention is that it ensures a good anchoring of the thermo sensitive layer to the high bright surface of the unprecoated paper, forcing the paper through a super calender in such a way that the smooth surface passes over steel rollers, which entirely close the surface, helping to obtain a highly smooth surface to receive the thermo sensitive layer.

Moreover, in this way the thermo sensitive layer is not detached from the base paper during the application of said layer, during its use in the printing equipment or afterwards in the handling of the print, retaining the quality of developed images and avoiding soiling the printing equipment.

In the present invention the color formation is based on an oxidation reaction that the color former suffers caused by acid substances and initiated by an external heat source. In this reaction the molecular ring of the color former is unfolded and opens forming a complex with the acid which is the color developer through a hydrogen bridge.

Within the reaction the effect of the sensitizers is important, since they work as promoting agents and form a eutectic composite controlling the melting point of the color formers and their developers. Its effect is also to contribute in obtaining a denser image.

For the present development a Diamino fluoran compound was selected as Black Color Former, with the following chemical description: 6′-(dibutylamino)-3′-methyl-2′-(phenilamine) Spiro (Isobenzofuran-1(3H),9-(9h)-xantheno)-3-one. The concentration of the color former in thermic ink was adjusted to provide the desired characteristics; concentration of the color developer takes place in the same way.

The color developers giving better results include, among phydroxybenzyl phenol, also available as Bis-(3 allyl-4-hydroxy phenyl) sulfone, benzyl butyl paraben, benzil4-hydroxybenzoate, 3,3-dimethyl-4-4 thiobiphenol. For the present development a no-phenolic developer such as a benzene sulfonamide derivative was chosen.

The most common sensitizers include Dibenzil Terephthalate, Dimethyl Terephthalate and Diarylether compounds. For the present development a Diarylether was chosen.

The pigments and white loads used in this development are: precipitated calcium carbonate, silica, titanium dioxide and calcined kaolin, with a particle size of 1.5 microns or less. White loads are selected by their surface area and particle shape. The calcium carbonates, calcined kaolin and silica are, among others, those providing combination possibilities. In order to increase the opacity of the recoated paper a mixture of Titanium Dioxide and synthetic pigments are used, although it is the property of absorption which determines a suitable combination of pigments. These pigments also help, among other things, to prevent a migration of the thermo sensitive layer to the thermal element.

The dispersals for fixing on the surface of the paper call for an adhesive, such as polyvinyl alcohol.

The present invention utilizes low viscosity partially hydrolized Polyvinyl Alcohols such as the product Elvanol 51-05 or kuraray 205 from 5 to 8 cps (centi Poises) and from 87-89% of hydrolysis, and incorporate specific starches as special adhesives for coating such as low viscosity hydroxyethyl and/or ethylates in the 100 to 300 cps range and terpolymer emulsions as binders, such as vinylacetate terpolymer, versatic acid vinylester (Veova) and plasticizer-free acrylic ester, for promoting an excellent moist or dry resistance.

Other necessary additives are surfactants, dispersants and defoamants in order to control the foam and for a suitable rheology in the formulations. The present invention has the novelty of adding an ideal mixture of surfactant liquid/air and defoamants to the formula. This addition has the double effect of softening the difference between peaks and valleys, typical of the coatings calibrated with the coating rod, and contributes with the adhesive in anchoring the thermo sensitive layer to the fiber of the high smoothness paper. In selecting the surfactant and defoamant, different kinds were evaluated and non-ionic types such as Surfynol 104 which develops multifunctional properties, and defoamants made from mineral oils and silica derivates, such as Drewplus 131, selected. With

Surfynol 104, on increasing molecular weight through a reaction which augments the number of ethylene oxide moles, a more hydrophilic surfactant is produced which moistens the substrate (high smoothness paper) under more dynamic conditions. The defoamants are added in strictly controlled proportions at a ratio of 1 to 1 and 1% with respect to the sensitizer, color former, and color developer.

In the present invention, the use of waxes or lubricant agents is considered as well as zinc stearate, in order to avoid the emission of dust or fines to the heat source.

In relation to other patents registered as described in patent WO2005084958 as of 15-09-2005, application of the thermo sensitive layer is normally done with high precision and rain control equipment, which implies utilizing equipment with a high investment cost. When the Coating Rod has been used to calibrate the freshly-applied thickness of the thermo sensitive layer, it drags the fresh emulsion and leaves a grooved surface which degrades the quality of the image to be generated by the thermal print. This technique is mentioned in U.S. Pat. No. 6,613,716 B2 as of 02-09-2003.

The formula object of this invention possesses rheological and tension surface characteristics which allow an optimum terse and smooth surface to be obtained from the thermo sensitive coating, not presenting the roughness in the form of grooves which is typical or characteristic of coatings whose freshly-applied thickness is calibrated by the use of coating rods. Additionally, the tenacity of the fresh emulsion and its adherence to the substrate (high smoothness paper), avoid contact with the coating rod carrying the fresh emulsion. This way, the double effect is achieved of the coating being at the same time terse, with an optimal smooth surface which contributes to the obtaining of highly defined images, and a complete coverage (avoiding the presence of non-sensitized areas).

It was found that papers with a smooth face have an evenness value of 80 cm/min measured on the Bendsten scale. These smooth values as compared with those presented by pre-coated paper are described in the following table:

TABLE No.1

| | | Bendsten Smoothness |
|---|---|---|
| Paper Description | Base Weight G/M² | cm³/min. |
| High Smoothness | 65 | 80 |
| Paper without pre- | | |
| coat | | |
| Pre-coated Paper | 67 | 76 |

Table 1 shows the Smoothness values for the papers used as a base for the thermal papers. The smoothness quality of a high smoothness paper without pre-coating is practically the same as with paper with pre-coating.

Opacity, which is another requirement given by pre-coating, is compensated in other processes by the introduction of a pigment which provides opacity to the thermo sensitive layer formula. In the present development this was obtained with a mixture of 50 pts Calcined Kaolin, 44 pts Calcium Carbonate, 5 pts Titanium Dioxide and 1 part Silicon Dioxide.

Preparation of the thermo sensitive layer implies individual preparation of the following reagents:
1. Reagent incorporating the color former: This is the color former plus part of the sensitizer, and a proportional part of the adhesive. Dispersal aids, defoamant agents and additives to regulate viscosity are present.
2. The acid reagent carrying the color developer comprising the sensitizer complement and the necessary adhesive to fix the formula. Dispersal aids, defoamant agents, dispersers and additives to regulate the viscosity are present.
3. Properly dispersed white loads
   Reagent preparation requires a milling process. The size of the particle should be close to 2 to 2.5 microns. The mills required for this operation should have a cooling jacket to prevent a rise in temperature during the process which results in a premature reaction.

A polyvinyl alcohol solution is prepared separately and combined with the components to be described later among the examples mentioned. Mixing begins in a moderate speed mixer and the percentage of solids controlled in accordance with the formula.

Following are 6 examples of the composition and preparation process of the Thermo Sensitive Layer suitable for High Smoothness Papers, as well as the results of each one following application over High Smoothness Paper.

### Example No. 1

The reagent containing the Color Former (Diamino fluoran Compound) is prepared as follows:

A 20% alcohol Polyvinyl Alcohol solution is prepared in a recipient which can be either 5 to 6 cps Elvanol or kuraray with a hydrolysis of 87 to 89%. At the same time in an 1,750 RPM Cowles mixer, 3 parts of the color former compound Diamino fluoran is added to 3.5 parts of Diarylether together with the previously-prepared Polyvinyl Alcohol representing 5 parts of the dry base, with Drewplus I-131 defoamant (mineral oils and silica derivatives) in a percentage of 0.05% as compared with the color former used, also incorporating a mixture of surfactants such as Surfynol 420 and Surfynol 104 representing 0.05% of the total.

The dispersal is introduced into a Mill with a water-cooled grinding chamber, until a particle size of 2.0 to 2.5 micron is obtained.

The Complementary Reagent containing the color Developer (a non-phenolic derivative of benzene sulfonamide) is prepared as follows:

A solution of 20% Elvanol 51-05 of from 5 to 6 cps and 87-89% hydrolysis is prepared in a recipient. The color developer is prepared in the same way as the reagent containing the color former. 8.5 parts of Developer are mixed with 1.5 parts sensitizer and milling is controlled to a particle size of from 2.0 to 2.5 micron.

Once the dispersals of both reagents has been completed, they are mixed inside a Cowles type mixer and the polyvinyl alcohol 5 pts dry base solution is incorporated in addition to a dispersal of Zink Stearate 35%, 15 parts (dry base) and a 50% paste of 25 parts Calcined Kaolin (dry base).

The paste prepared in this way is adjusted at a viscosity of 15 seconds in Ford cup No. 6. In this phase a combination of dispersal agents and defoamants must be added in order to control the fluidity of the thermo sensitive layer.

Below is a table showing the composition of the mixture used in this first example:

| Description | Dry base amount |
|---|---|
| Diamino fluoran compound | 3.0 |
| Non-phenolic benzene sulfonamide | 8.5 |
| derivative developer | |
| Diarylether sensitizer compound | 5.0 |
| Elvanol 51-05 5 to 6 cps 89-89%, 20% | 10.0 |
| hydrolysis in solution | |
| Zinc Stearate at 30% | 15 |
| Calcined kaolin paste at 50% | 25 |
| Drewplus L191 defoamant | 0.15 |
| Surfactant Surfynol104 and 420 (2,4,7,9 | 0.15 |
| Tetra methyl-5 decine-4,7 diol) | |

### Example No. 2

Following the same form of preparation for both reagents as in EXAMPLE No. 1, the following mixture was prepared:

| Description | Dry Base amount |
|---|---|
| Diamino flouran compound | 3.5 |
| A non-phenolic developer derived from | 8.5 |
| benzene sulfonamide | |
| Diarylether compound Sensitizer | 5.0 |
| 46-66 WF hydroxyethyl starch at 20% | 2.5 |
| Elvanol 51-05 5 to 6 cps 87-89% | 2.5 |
| hydrolysis at 20% in solution | |
| Dispersal of vinyl acetate terpolymer, | 5.0 |
| Veova, and acrylester | |
| Zinc stearate at 30% | 15 |
| Calcium Carbonate paste at 30% | 25 |
| Drewplus L191 Defoamant | 0.1 |
| Surfactant Surfynol 104 and 420 | 0.1 |
| (2,4,7,9 Tetra methyl .- 5 decine-4, 7 | |
| diol) | |

A proportion of chemically modified starch of the kind widely used as co-binders in water-based coatings was introduced in this example. This improves the adhesive power and the starch is plasticized in order to form a more flexible film with materials such as polyvinyl alcohol, as well as taking advantage of the property of the starch as a flow regulator. A terpolymer dispersal (of EVA, Veova (versatic acid vinyl ester) and of acryl ester was also introduced in order to balance coating characteristics, consisting of a combination of three monomer units which increase the adhesive force between paper fibers and the thermo sensitive color layer, without altering its image-reproducing properties.

### Example No. 3

The same method of preparation is followed in this example as in the two previous cases:

| Description | Dry Base amount |
|---|---|
| Diamino fluoran compound | 3.5 |
| A non-phenolic developer derived from | 8.5 |
| benzene sulfonamide | |
| Diarylether compound sensitizer | 5.0 |
| 20% 46-66 WF hydroxyethyl starch | 2.5 |
| Elvanol 51-05 5 to 6 cps 87-89% | 2.5 |
| hydrolysis at 20% | |
| Vinyl acetate terpolymer, Veova, and | 5.0 |
| acrylester dispersal | |
| Pigment mixture at 50% | 25 |
| Zinc stearate at 30% | 15 |
| Drewplus L191 defoamant | 0.1 |
| Surfactant Surfynol 104 and 420 (2,4,7,9 | 0.1 |
| Tetra methyl-5 decine-4, 7 diol). | |

In this formula the reactors, color Former and color Developer are prepared as described in example no. 1, and a pigment mixture is prepared independently to provide greater covering power, even though the weight of the thermo sensitive layer is less. This mixture consists of 50 pts calcined kaolin, 44 pts calcium carbonate, 5 pts Titanium Dioxide (Rutile grade), and 1 part Silicon dioxide, and is prepared by moisturizing components in diethyl glycol and Astropol 30 and subsequently passing through a roller mill.

Once the preparation has been completed it is applied over different papers, a high smoothness paper of 65 g/m2 and a pre-coated paper of 67 g/m², as shown in Results table II.

The Coating Rods system and rod no. 6 are used to apply the thermo sensitive layer in order to deposit 4 to 6 g/m².

### Example No. 4

The following formula was used in this example:

| Description | Dry Base amount |
|---|---|
| Diamino fluoran compound | 3.5 |
| A non-phenolic developer derived | 8.5 |
| from benzene sulfonamide | |
| Diarylether compound sensitizer | 5.0 |
| Ethyl starch at 20% | 4.0 |
| Elvanol 51-05 5 to 6 cps 87-89% | 6.0 |
| hydrolysis at 20% | |
| Calcium Carbonate paste at 50% | 25 |
| Zinc stearate at 30% | 10 |
| Drewplus L191 defoamant | 0.1 |
| Mixim Antioxidant ao-30 | 0.1 |
| Surfactant Surfynol 104 and 420 | 0.1 |
| (2,4,7,9 Tetra methyl-5 decine-4, | |
| 7 diol) | |

The color former and color Developer reagents are prepared as described in example no. 1, where the pigment paste is based on Calcium carbonate prepared by moisturizing as described in example 3. The resulting paste is finished at 50% solids. In this example the purpose is to make the aging-resistant paper achieve a lasting image, which is developed through antioxidant papers which avoid yellowing and a loss of image. The final mixture comprising the thermo sensitive layer is deposited through the Coating Rod mechanism.

### Example No. 5

The following formula was used in this example:

| Description | Dry Base Amount |
|---|---|
| Diamino fluoran compound | 3.5 |
| A non-phenolic developer derived | 8.5 |
| from benzene sulfonamide | |
| Diarylether composed Sensitizer | 5.0 |
| Hydroxyethyl starch of 20% | 4.0 |
| Elvanol 51-05 5 to 6 cps 87-89% | 6.0 |
| hydrolysis at 20% in solution | |
| Calcined kaolin paste at 50 | 25 |
| Zinc stearate at 30% | 15 |
| Drewplus L131 defoamant | 0.1 |
| Surfactant Surfynol 104 and 420 | 0.1 |
| (2,4,7,9 Tetra methyl-5 decine-4, | |
| 7 diol) | |

The preparation of the reagents color Former and color Developer are prepared as described in example no. 1, in this example the pigment paste is based on calcined kaolin, prepared by moisturizing as described in example 3.

This example shows the difference between papers presenting a resistance to aging as in the thermo sensitive layer of example 4.

### Example No. 6

The following formula was used in this example:

| Description | Dry Base Amount |
|---|---|
| Diamino fluoran compound | 3.5 |
| A non-phenolic developer derived from | 8.5 |
| benzene sulfonamide | |
| Diarylether composed Sensitizer | 4.0 |
| Elvanol 51-05 5 to 6 cps 87-89% hydrolysis | 6.0 |
| at 20% | |
| Mixim antioxidant Ao-30 | 0.1 |
| Pigment mix at 50% | 25 |
| Zinc stearate at 30% | 10 |
| Drewplus L191 defoamant | 0.1 |
| Surfactant Surfynol 104 and 420 (2,4,7,9 | 0.1 |
| Tetra methyl-5 decine-4, 7 diol) | |

Each one of these examples was prepared according to example no. 1 utilizing the equipment described. The size of the particle should be between 2.0 and 2.5 microns. Thermal color preparations developed in this way, were applied on two types of paper using rod no. 6 to deposit an average of 4 to 6 g/m². Viscosity was adjusted in every Results of these examples appear in the following table

TABLE No. II

| | High Smoothness Paper 65 | |
|---|---|---|
| | g/m² | Pre-coated paper 67 g/m² |
| | IMAGE INTENSITY | IMAGE INTENSITY |
| Example 1 | Better image definition | Defined image |
| Example 2 | Better image definition | Defined image |
| Example 3 | Better image definition | Defined image |
| Example 4 | Better image definition | Defined image |
| Example 5 | Better image definition | Defined image |
| Example 6 | Better image definition | Defined image |

A Zebra Atlantek thermal printer and a 1200 Macbeth

Densitometer were used to evaluate the IMAGE INTENSITY. Examples 1 to 6 were covered over two different types of paper, one pre-coated with a Kaolin Coat and Natural and Synthetic Adhesives such as Starch and Styrene Butadiene Latex, and a paper without coating but presenting HIGH SMOOTHNESS on one of the faces which, as mentioned elsewhere, occurs mainly because during the manufacturing process and while moist, it is placed in contact with a high bright metal surface and the composition of the pulp favors this HIGH BRIGHT effect. One can appreciate the Smoothness obtained from the results shown in TABLE I.

Text images were generated; logos with dark areas and bar codes were copied. Texts were put through a scanner and successfully processed in optic character recognition software. The solid color areas of the logo figures were satisfactory as regards density.

The best results were obtained when either hydroxyethylated or ethylated starch or terpolymer dispersal as in examples 3, 5 and 6, were added to the binder. In these examples, the presence of a combination of white pigments or loads also influences an improvement in the print. From these examples, the paper with more adhesiveness between the thermo sensitive layer and the base is example 3, due to the presence of a terpolymer in the formula as binder.

The Coating Rod mechanism is used to apply the thermo sensitive layer utilizing Rod no. 6, thus achieving a uniform distribution of the thermo sensitive layer weight of from 4 to 6 g/m² is obtained over the entire width of the paper tape, without the need for a system as complex as that used by the grooving system.

In comparing the intensity of images obtained using the foregoing process with others obtained employing sensitive papers utilized by other processes, it can be seen that those obtained from the present process are in some cases better, or at least the same.

Taking into consideration everything contained in existing Patents and the cost of the end product for placement on the market, a process was developed to provide an opportunity of competing in cost-price by lowering raw material and processing costs and thus of and process and thus providing an opportunity to deliver a product of similar quality at a lower price.

The first stage of the investigation was dedicated to finding a basic paper whose characteristics and specifications permitted one face to have the high smoothness and low absorption conditions claimed in producing a coated paper with a heat-sensitive coating, allow this layer to be received without its response being affected in heat-applied printing.

From this selective investigation it was found that the base paper which provided the smoothness and absorption properties required is a paper manufactured and dried over a dryer with a chromed surface allowing the paper surface to possess the smoothness required to receive coatings without surface problems. This type of paper is known as Monolucid.

To improve the Monolucid paper surface even more and decrease absorption, it had to be placed on a calender via iron rods and cotton, thus obtaining a paper able to receive the thermo sensitive layer and retaining a surface with the required smoothness and absorption.

Once the Paper serving as a base for the heat-sensitive material layer was obtained, the formula or formulas of this were developed for surface application in order to complete the product.

In developing composition of the thermo sensitive layer for application on the surface of the Monolucid paper to be used as a base, another specific condition required to utilize suitable coating equipment was found, this being utilization of the Coating Rod System as the sole economic solution. The sensitive layer would therefore have to be adjusted for suitable placement with this equipment only uses as being the only economic one, the composition of the sensitive layer would need to be adjusted in order to be suitably placed with this equipment, requiring specific formulas to provide the fluidity and mobility for use of the available equipment. Many formulas had to be tested for use without infringing on knowledge already protected under previous patents.

1-17. (canceled)

18. A thermal paper for the printing of images and texts in thermal printers, comprising: a substrate of a high smoothness paper not previously covered, and an applied emulsion layer which, on drying, forms a thermo sensitive layer; the layer comprising color former components; a color developer; a sensitizer; at least one surfactant additive selected from a group consisting of non-ionic, mineral oil based foam controllers, silica and surfactants derivatives, and an adhesive comprising a partially hydrolyzed low molecular weight polyvinyl alcohol having a controlled viscosity of 5 to 6 cps, a modified starch selected from ethyl hydroxyethyl low viscosity starches of between 100 and 300 cps (Brookfield), and a dry base binder of terpolymer vinyl acetate, vinyl ester or plasticizer-free acrylester.

19. A thermal paper according to claim 18 wherein the layer is applied to the base paper by a coating rod system.

20. A thermal paper according to claim 18, wherein the surfactant additive composition includes a surfynol or surfynol 420 non-ionic compound.

21. A thermal paper according to claim 20, wherein the non-ionic compound is 2,4,7,9-tetramethyl-5-alkyne-4-7-diol.

22. A thermal paper according to claim 20, wherein the surfactant additive further comprises contains a defoamant agent consisting of a combination of mineral oils, silica and surfactant derivatives.

23. The thermal paper according to claim 18 wherein the modified low viscosity starches have a viscosity of below 200 cps, and the partially hydrolyzed polyvinyl alcohol has a viscosity of 6 to 7 cps, with a hydrolysis percentage of 88%.

24. The thermal paper according to claim 18 wherein the hydrolyzed low viscosity polyvinyl alcohol is of from 6 to 7 cps, and has a degree of hydrolysis from 86 to 89% to assist in stabilization of the thermo sensitive color formula.

25. A process for manufacturing thermal paper, comprising the application of an substrate aqueous emulsion to a smoothness paper, the emulsion comprising color former, color developer and sensitizer components, at least one surfactant additive, selected from among a group consisting of the non ionic mineral oil based defoamants, silica and surfactant derivatives, and an adhesive having a low molecular weight partially hydrolyzed polyvinyl alcohol with a controlled viscosity of 5 to 8 cps, a modified starch selected from low viscosity ethylated and hidroxyethylated starches of between 100 to 300 cps (Brookfield), and a dry base of plasticizer-free polymer of vinyl acetate, vinyl ester and acrylic ester.

26. The process according to claim 25, wherein the emulsion is applied by use of a calibrated coating rod system.
